(19) United States
(12) Patent Application Publication
(10) Pub. No.: US 2024/0169287 A1
(43) Pub. Date: May 23, 2024

(54) STAFF REQUIREMENT COMPUTATION FOR SYNCHRONOUS AND ASYNCHRONOUS WORK ITEMS

(71) Applicant: NICE LTD., Ra'anana (IL)

(72) Inventors: William Nathan STEARNS, Richardson, TX (US); Brenda HANSEN, Kamas, UT (US)

(21) Appl. No.: 18/055,694

(22) Filed: Nov. 15, 2022

(51) Int. Cl. G06Q 10/06; G06Q 10/04

(52) U.S. Cl. CPC G06Q 10/063118; G06Q 10/04

(57) ABSTRACT

Interval-specific, activity-based systems and methods, and non-transitory computer readable media, including activity-based data acquisition, activity-based forecasts, and activity-based staffing. Work items are automatically decomposed into data that is usable for workforce management purposes at the interval level. Volume/average handle time forecasts, staff requirement calculations, and schedules are driven by historical patterns of interval-specific activity required to resolve long duration work items.

### TECHNICAL FIELD

The present disclosure relates generally to methods and systems for determining staffing needs for an organization, and more specifically relates to methods and systems that use interval-specific, activity-based analysis to compute staffing requirements for an organization.

### BACKGROUND

Workforce management (WFM) applications have two major limitations. Work items that span more than one time interval are treated as a single work item that occurs in a single time interval. In addition, asynchronous work items are treated the same as synchronous work items. Both limitations lead to planning and scheduling inaccuracy within each time interval. A time interval (also known in the art as a “planning interval” when calculating staffing needs for a given time period) is the period of time where volume, average handle time (AHT), and staffing requirements are calculated for the purpose of generating schedules and managing service objectives.

Specifically, traditional data acquisition, forecast algorithms, and staff requirement calculations do not compute interval-specific work activity (e.g., contacts, touch points, or actions) for work items (e.g., cases, tickets, or message threads) that span more than one time interval. As a result, traditional staff requirement calculations assume all the work activities associated with a work item occurred in the time interval in which the work item ended, even though the work activities occurred in one or more prior time intervals. This is true regardless of whether the work item is asynchronous or synchronous. Therefore, traditional staff requirement calculations are not based on interval-specific work activities.

As a result, the use of traditional data acquisition, forecast algorithms, and staff requirement calculations for work items with durations longer than one time interval result in inaccurate staffing requirements for each time interval. These inaccuracies lead to sub-optimal resource utilization, especially in blended work environments, such as back office work items blended with contact center work items, or omni-channel contact centers.

Currently, there are two industry standard methods to calculate staff requirements in a time interval. The first method reports the total time required to complete a work item in the time interval in which the work item ends, and the second method reports the time required to complete a work item as it occurs throughout the time intervals.

The first standard method is the most common practice in contact centers, back offices, and other environments that process work items. If the work item ends in the time interval in which it began, the first method generally provides accurate volume and handle time data per time interval to calculate the staff required to handle the work items in the time interval. If the work item ends in a time interval after which it began, the first method does not generally provide accurate volume and handle time data per time interval to calculate the staff required to handle the work items that span multiple time intervals.

The second standard method is an attempt to resolve the inaccuracies that occur in the first method when a work item spans more than one time interval. The most common approach using this method is to report the time employees worked on items only in the time interval in which the work occurred. For example, if a work item spans three time intervals, but the employee only worked on the item in the first and third intervals, the time spent working on the item in the first interval is reported only in the first interval, no time is reported in the second interval, and the time spent working on the item in the third interval is reported only in the third interval. Although this data acquisition practice helps address the inaccurate time accounting for each interval, it creates another data acquisition inaccuracy in common with the first method.

The common inaccuracy of the first method and the second method is that both methods only count the work item once. The first method counts the work item once in the interval it ended. The second method counts the work item once when it was started or answered. Neither method considers the fact that the work item has a lifespan across intervals and therefore should be counted in multiple intervals. The reason the work item is counted only once in both the first and second methods is due to the underlying design of current WFM systems. Specifically, WFM systems are designed to capture work items rather than work activity. Work items are counted only once so that key performance indicators (KPIs) such as service level, average speed of answer (ASA), abandon rate, call volume, ticket volume, and case volume can be calculated. If a call or a case ticket is counted in each interval in which it was handled or existed, then the KPIs would be inaccurate based on the standard methods.

Accordingly, a need exists for improved systems and methods that will reduce the inaccuracies of computing staff requirements for asynchronous and synchronous work items, especially when the work items span more than one time interval.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a system according to various embodiments of the present disclosure.

FIG. 2 is a flowchart of a method according to embodiments of the present disclosure.

FIG. 3 is an exemplary screen shot of a WFM administrative screen according to embodiments of the present disclosure.

FIG. 4 is an exemplary screen shot of a WFM queue history screen for an organization using the work item-based staffing requirement option.

FIG. 5 is an exemplary screen shot of a WFM queue history screen for an organization using the activity-based staffing requirement option according to embodiments of the present disclosure.

FIG. 6 is an exemplary screen shot of WFM intraday analysis screen for an organization using the activity-based staffing requirement option according to embodiments of the present disclosure.

FIG. 7 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, user interface, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

According to various embodiments, the present methods and systems analyze work item event streams to automatically decompose asynchronous and synchronous work items that span multiple time intervals for the purpose of creating interval-specific addressed and active volume counts, as well as handle (processing) time which occurred in the interval when the work item was addressed or active. Synchronous and asynchronous work items that have a lifespan longer than the smallest time interval (also referred to herein as the lowest common denominator) are decomposed into activity-based work history. The decomposed work activity pattern data is then fed into WFM forecast algorithms and staffing requirement calculations to render staffing patterns that represent the true interval-specific workload associated with asynchronous and synchronous work items.

Work items that span more than one time interval must be analyzed and counted across the entire lifespan to more accurately capture activity data, while ensuring that core KPIs are not negatively impacted (at least, in terms of accuracy). In the systems and methods described herein, handle time data capture is true to interval, meaning that data for work items is reported within the interval the work activity associated with the item occurs, rather than waiting until a future interval when the work item is finished (e.g., completed, resolved, or closed).

As used herein, “addressed” means that a work item is initially answered, initially connected to, or initially assigned to an employee. As used herein, “active” means that a work item has the focus of an employee.

An asynchronous work item is a conversation, dialog, or messaging between a customer and an employee (e.g., a contact center agent) that is intermittent, sporadic, or discontinuous, such as an email, a chat, a post on a forum, a message on a messenger application, a post on a social networking site, a text, an in-app message, a search on a search engine, or a combination thereof. There are frequent pauses or breaks in the flow of the conversation, dialog, or messaging. In many situations, the customer and/or the employee are not fully engaged and may be easily distracted by other work items.

A synchronous work item, on the other hand, is a conversation, dialog, or messaging between a customer and an employee that is continuous, such as a telephone call, an interactive voice response (IVR), an instant message, a live chat, a video chat, a live meeting, or a combination thereof. Although there may be pauses or breaks in the flow of the conversation, dialog, or messaging, the customer and the employee are fully engaged and not as easily distracted by other work items.

In several embodiments, the present methods and systems create interval-specific data that represents actual historical work activity patterns associated with work items that have long lifespans, whether the work item is continuous (synchronous), but spans more than one time interval, or the work item is intermittent (asynchronous) and spans more than one time interval. In one or more embodiments, the present methods and systems provide activity-based data acquisition that analyzes real-time event streams or historical event data to identify work item activities, calculate work item activity statistics that are true to interval, and capture addressed and active work item volume per time interval.

In various embodiments, the present methods and systems provide activity-based forecasts that analyze interval-specific work activity historical patterns, forecast interval-specific work activity volume, and forecast interval-specific work activity AHT. Work activity includes the tasks, actions, messages, postings, responses, reading, or composing required to resolve a work item. The work activity may be synchronous or asynchronous in nature. Work activities may be performed by more than one employee over the lifespan of a work item. Handle time indicates the total time that employees are working on work items in a time interval. Handle time may also refer to the total time required to complete a work item even when the work item spans more than one time interval. In some embodiments, the present methods and systems provide activity-based staffing that calculates the staff required to complete the forecasted work activity in each time interval.

The business problem of work items that have lifespans longer than a time interval, and the accuracy of tracking various workflow items, is a decades old issue for WFM systems. It is a problem that has never had a meaningful solution, despite introduction of early WFM systems in the 1980s. The recent rapid adoption of asynchronous digital channels has further exacerbated the problems discussed herein, and no WFM solution has offered a suitable resolution to the issues of planning and scheduling for asynchronous work items.

Therefore, the present systems and methods represent a paradigm shift from “when a work item ended case-based reporting” to “true-to-interval activity-based event analysis and reporting” for the purpose of normalizing work items into work activity patterns at the lowest common denominator for time intervals. The present systems and methods shift the focus from reporting data when a work item ended to analyzing and reporting data when activity for a work item occurred. The systems and methods described herein provide an advantageous advance whereby work items are automatically decomposed into data that is usable for WFM purposes at the planning interval level, where the planning interval level is the lowest common denominator. Volume/AHT forecasts, staff requirement calculations, and schedules are driven by historical patterns of interval-specific activity required to resolve long duration work items with long duration service level agreements, while simultaneously planning short duration work items with short duration service level agreements.

Advantageously, the present systems and methods improve technology by solving a long-standing issue of accurate representation of long duration asynchronous/synchronous work items for the purpose of calculating staffing requirements in advance of need. In addition, the operation of a computer is improved through the automation of a more granular analysis of how much work is performed and when the work time is actually applied to a work item that has a long lifespan to analyze past data to facilitate future predictive staffing calculations. A human is incapable of completing such an analysis to achieve the same results due to (1) the extremely large transitory data sets of events and activities associated with a work item, and (2) the need to retain the state of a work item in memory over the course of time to ensure correct accounting of activities that occur for a single work item with a long lifespan, i.e., over multiple time intervals.

Furthermore, the present systems and methods address an ever-increasing volume of customer complaints about inaccurate WFM data and staffing requirements when asynchronous channels are deployed or when synchronous channel handles times exceed a time interval. The present systems and methods enhance the WFM solution offered to siloed environments or blended environments by decomposing and normalizing dissimilar work items into a common level of planning intervals across all work streams. Moreover, the systems and methods described herein solve the problems caused by waiting until long work items end before data is reported to the WFM system.

The proliferation of digital channels is increasing the volume of long asynchronous interactions that do not fit traditional WFM design constraints. A WFM solution according to the present disclosure supports the staffing requirements for such new digital channels that involve asynchronous interactions.

The proliferation of customer self-service is also increasing the complexity of synchronous and asynchronous interactions handled by employees, thus increasing the AHT for both synchronous and asynchronous contacts to be longer than the WFM planning interval. As such, a WFM solution according to the present disclosure addresses the trend of work items with lifespans longer than a single time interval.

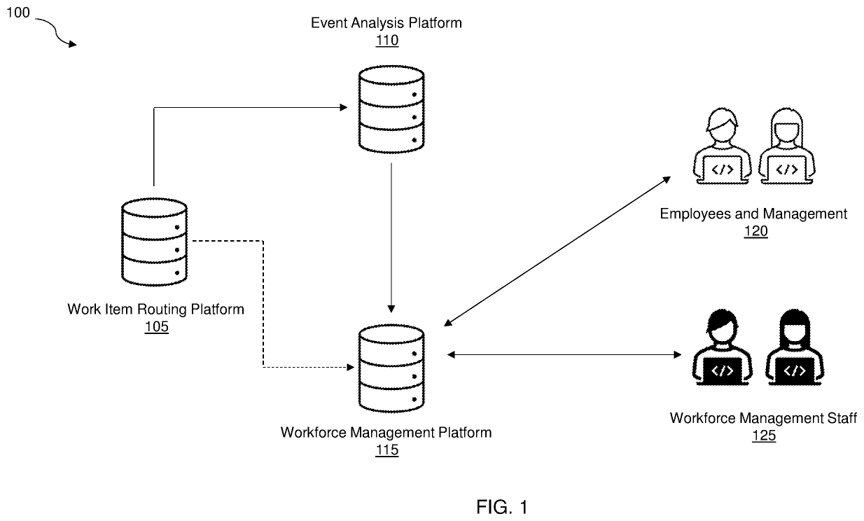

FIG. 1 illustrates a system 100 according to various embodiments of the present disclosure. System 100 includes Work Item Routing Platform 105, Event Analysis Platform 110, WFM Platform 115, Employees and Management 120, and WFM Staff 125. Work Item Routing Platform 105 is the system that manages the prioritization and routing of work item assignments to employees. This system may be cloud-based or on-premise, and maintains data for the work item in real-time (i.e., while the work item is open or unresolved) as well as historically (i.e., when the work item is closed or resolved).

In certain embodiments, Work Item Routing Platform 105 creates an event or signal when a work item becomes active with an employee. The event may be stored in a historical database or held in memory for a period of time. The event may be made accessible via a database query or an API call to push or get the event as it occurs. A work item can be active many times across multiple time intervals over the lifespan of the work item. The work item can be reassigned to a different employee over the course of the lifespan of the work item. Regardless of the current assignment, each time a work item becomes active, a record is created.

In several embodiments, Work Item Routing Platform 105 creates non-aggregated, real-time or historical events for the lifecycle of a work item. The events represent state transitions during the lifespan of the work item, which capture the start, the end, and any state change within the lifespan. Events also capture employee contact events of start, end, and any in-focus change while the employee is working on the work item.

Examples of a work item routing platform 105 include an inventory management platform, a digital channel platform, an automatic contact distributor (ACD), or a claim, case, or ticket system,. Typically, an ACD routes telephone calls, but any type of work item or communication can be given a digital signature and routed via the ACD.

In an exemplary embodiment, Work Item Routing Platform 105 includes an ACD. ACDs are specialized systems that are configured to match a work item to an available employee. ACDs generally receive incoming work items, determine where to route a particular work item, and connect the work item to an available employee. For the purposes of the present disclosure, “ACD” refers to any combination of hardware, software and/or embedded logic that is operable to automatically distribute incoming work items, including requests for service transmitted using any audio and/or video means, including signals, data or messages transmitted through voice devices, text chat, web sessions, facsimile, instant messaging and e-mail.

According to one or more embodiments, ACD includes a processor, a network interface, and a memory module or database. The network interface joins ACD with a local area network. Once ACD receives a work item, the processor determines which of a plurality of employees should receive the work item. For example, the processor may access the memory module, which stores code executed by the processor to perform various tasks.

In various embodiments, the processor includes a plurality of engines or modules. Examples of suitable engines include a distributor engine, a queue engine, and a monitor engine. The distributor engine distributes incoming work items to available employees, the queue engine monitors and maintains work items that are waiting to be connected to employees, and the monitor engine checks the status and skills of employees and stores appropriate information in the memory module.

Event Analysis Platform 110 analyzes each work item's events to create interval-specific work activity records and summaries. Event Analysis Platform 110 may be deployed with Work Item Routing Platform 105, or as a separate platform that receives data from Work Item Routing Platform 105.

In various embodiments, Event Analysis Platform 110 includes a consolidator, a consolidated data store, an aggregator, and a publisher. The consolidator receives raw data from Work Item Routing Platform 105. The raw data is interpreted and consolidated into records that describe the events that occur during the lifespan of a work item. The consolidated records are then written to the consolidated data store with the relevant details to allow extraction to create summary statistics. In one embodiment, DynamoDB is used as temporary storage of the consolidated records. The temporary storage houses aggregated contact, employee contact, employee activity, and employee session details as queryable content meant to source downstream WFM solutions. The aggregator retrieves the description records from the consolidated data store to create interval specific summaries of activities. In some embodiments, at specified intervals, the stored activity records are retrieved for analysis and summarization. In one embodiment, there are three separate sections of data summarized: queue details, employee queue details, and employee system performance details. In certain embodiments, the time interval is user-defined and represents the smallest planning time interval (or the lowest common denominator) of the time intervals in the records. The publisher collects the interval summaries and pushes them to WFM platform 115.

In one or more embodiments, as each event occurs or as each event is read from a historical data store, a process determines if a database record should be created to record the event as a reportable activity. The process may be user-defined or system-defined to establish the parameters that cause a historical activity record to be created. In one embodiment, the non-aggregated, real-time events that represent the lifespan of a work item and the employee interactions with that work item are monitored and stored in memory until certain configurable parameters are met. For example, the parameters may be when the work item ends, when the work item is reskilled (i.e., when a different agent skill is required to handle the work item than the initially determined agent skill), or when the work item spans a configurable interval boundary into multiple time intervals. When a parameter is met, a summary, including aggregated rows with calculated field values are written to a database.

WFM Platform 115 is a specialized system that receives data from Event Analysis Platform 110 and/or Work Item Routing Platform 105. In several embodiments, WFM Platform 115 uses the received data to create a forecast of volume and AHT, calculate staffing requirements, generate optimized schedules, and manage changes to the forecasts, staffing requirements, and schedules. In one or more embodiments, WFM Platform 115 generates forecasts, calculates staff requirements, optimizes schedules, manages changes, monitors performance, and performs reporting.

Employees and Management 120 are the end users whose primary role is to work the schedules and manage the employees. WFM Staff 125 are the end users whose primary role is to administer WFM Platform 115, and create and manage the forecasts, staff plans, and schedules.

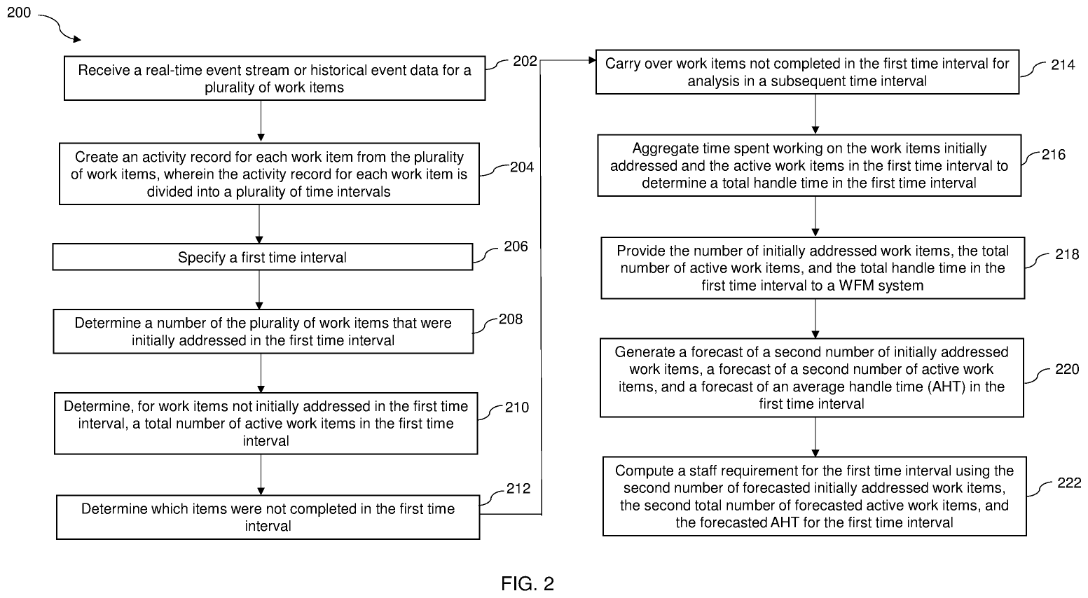

Referring now to FIG. 2, a method 200 according to embodiments of the present disclosure is described. At step 202, Event Analysis Platform 110 receives, from Work Item Routing Platform 105, a real-time event stream or historical event data for a plurality of work items. According to various embodiments, an event stream is a series of messages or signals that occur for each work item that is open. The message or signal indicates the current state of the work item. A work item includes a case, a ticket, an email, a contact, a call, or an interaction that represents a customer's experience from start to finish. Many work activities may be required to resolve or close a work item. A work item arrives on one of many different channels (e.g., voice, digital, social media monitor and listen, search, in-app messaging, messaging, collaboration, etc.) and may even transition to a different channel or a different employee during the lifespan of the work item.

At step 204, Event Analysis Platform 110 creates an activity record for each work item from the plurality of work items. The activity record for each work item is divided into a plurality of time intervals. In various embodiments, the time interval is user-defined. For example, the time interval may be about 15 minutes to 30 minutes, about 1 to 12 hours, or about 12 to 24 hours. In various embodiments, a work item is handled by multiple employees across multiple time intervals.

At step 206, Event Analysis Platform 110 specifies a first time interval. The first time interval may be the same or different than the time intervals in the activity records. In an exemplary embodiment, the first time interval is about 15 minutes to about 30 minutes. In several embodiments, the time interval is selected to be the smallest time interval or planning interval in the activity records.

At step 208, Event Analysis Platform 110 determines a number of the plurality of work items that were initially addressed in the first time interval. Work items that are initially addressed encompass the initial connection or assignment of a work item to an employee. This initially addressed count can be used downstream to calculate KPIs such as the number of contacts answered, service level, or ASA.

At step 210, Event Analysis Platform 110 determines, for work items not initially addressed in the first time interval, a total number of active work items in the first time interval. A work item is active when a work item has the focus of an employee. In various embodiments, an active work item is user-defined or system-defined. For example, a work item becomes active when an employee retrieves the inactive work item, or when a window with a previously retrieved work item on a desktop comes into focus by the employee clicking on the window. In this step 210, work items that were or were not completed, and were active in that time interval, are counted. This data is used to calculate work activity (rather than work items) and adjust the AHT according to the activity that occurred in the interval.

At step 212, Event Analysis Platform 110 determines which work items were not completed in the first time interval. This step counts the number of work items not yet completed and still in progress, and that have crossed the first time interval into a subsequent time interval.

At step 214, Event Analysis Platform 110 carries over work items not completed in the first time interval for analysis in a subsequent time interval.

In certain embodiments, Event Analysis Platform 110 further determines, for the work items not completed in the first time interval, a total number of active work items in one or more subsequent time intervals. For example, Event Analysis Platform 110 determines whether a work item not completed in the first time interval was active in the second, third, fourth, fifth time interval, and/or any future time interval.

At step 216, Event Analysis Platform 110 aggregates time spent working on the work items initially addressed in the first time interval and aggregates time spent working on the active work items in the first time interval to determine a total handle time in the first time interval. The total handle time can refer to the total handle time across the employee or for multiple employees in the first time interval, the total handle time of initially addressed work items across the employee or for multiple employees in the first time interval, or the total handle time of active work items across the employee or for multiple employees in the first time interval. In one embodiment, all the employees' time spent working on both the initially addressed work items and the active work items in the first time interval is accumulated to determine the total handle time across the employee or for multiple employees in the first time interval. In another embodiment, all the employees' time spent working on the initially addressed work items is accumulated to determine the total handle time of initially addressed work items across the employee or for multiple employees in the first time interval, and all the employees' time spent working on the active work items is accumulated to determine the total handle time of active work items across the employee or for multiple employees in the first time interval.

At step 218, Event Analysis Platform 110 provides to WFM Platform 115 the total number of initially addressed work items in the first time interval, the total number of active work items in the first time interval, and the total handle time in the first time interval. In one embodiment, DynamoDB is used to store summarized statistics that are transferred at the end of every specified time interval to WFM Platform 115. In various embodiments, the interval summary data is permanently stored in the database.

In one or more embodiments, the interval summary data is retrieved by WFM Platform 115, and the summary data is associated to an organization for the purpose of generating a forecast, calculating a staffing requirement, and optimizing schedules for the organization. In an exemplary embodiment, the organization is a contact center, and the employees are contact center agents.

At step 220, WFM Platform 115 generates a forecast of a second number of initially addressed work items in the first time interval, a forecast of a second total number of active work items in the first interval, and a forecast of an AHT (in aggregate for all work items, or specific to initially addressed work items and specific to active work items) in the first time interval. This step generates a forecast of activity volume and activity AHT using activity patterns as inputs rather than work item arrival patterns as inputs. This process uses existing or new forecast algorithms that may be developed based on at least the guidance herein. AHT describes the amount of time, on average, that is required to resolve a work item or perform a work activity for an employee or for multiple employees.

At step 222, WFM Platform 115 computes a staff requirement for the first time interval using the second number of forecasted initially addressed work items, the second total number of forecasted active work items, and the forecasted AHT for the first time interval. This step uses the forecast of activity volume, activity AHT, and the appropriate service objective for the type of work item. The process uses existing or new calculations that may be developed.

For illustrative purposes, assume a work item arrives at 8:10 AM and completes at 8:35 AM. Using traditional methods, the work item is not decomposed and the staff requirement is calculated as shown in Table 1.

TABLE 1
TRADITIONAL “WHEN WORK ITEM ENDED” PARADIGM

| | | Handled | | Staff |
|---|---|---|---|---|
| Time Interval | Received | (Completed) | Handle Time | Requirement |
| 8:00 am | 1 | 0 | 0 | 0 |
| 8:15 am | 0 | 0 | 0 | 0 |
| 8:30 am | 0 | 1 | 25 | 1.7 |

This method is effective when most work items arrive and complete in the same interval, there are low queue delays, longer planning intervals are used, and there are shorter handle times. Long handle times, however, are only reported in the completing interval. In addition, the handle time is only reported in the interval where most of the work was not done. The traditional method produces inaccurate staff requirement values in each planning interval.

In contrast, with method 200, the work item is decomposed and the staff requirement is calculated as shown in Table 2.

TABLE 2
ADDRESSED AND ACTIVE TRUE TO INTERVAL PARADIGM

| | | | | Handle | Staff |
|---|---|---|---|---|---|
| Time Interval | Received | Addressed | Active | Time | Requirement |
| 8:00 am | 1 | 1 | 0 | 5 | 0.33 |
| 8:15 am | 0 | 0 | 1 | 15 | 1 |
| 8:30 am | 0 | 0 | 1 | 5 | 0.33 |

Method 200 is effective when asynchronous work items span multiple intervals (even non-sequential intervals) and have long lifespans. Method 200 is also effective for synchronous work items that are either shorter than the interval or longer than the interval. Advantageously, handle time is reported in the interval it occurred. Method 200 produces highly accurate staff requirement values in each planning interval.

Below are additional illustrative examples of method 200.

Assume the below activity record is created by Event Analysis Platform 110 for a first time interval of 15 minutes for a plurality of work items. In this example, all the work items are assigned concurrently to a single employee. Other assignment methods (e.g., the work items are assigned to more than one employee) are also supported.

TABLE 3
ACTIVITY RECORD FOR FIRST TIME INTERVAL

| | Service Chat | | | |
|---|---|---|---|---|
| | [symbol] Initially | | | |
| | Addressed in a | Service | Service | Service |
| Minute | Previous Interval | Chat | Twitter | Facebook |
| 1 | Active | | | Queued |
| 2 | Active | | Queued | Addressed |
| 3 | Active | | Addressed | |
| 4 | | | Active | |
| 5 | Active | | | |
| 6 | | | | Active |
| 7 | Active | | | |
| 8 | Active | | | |
| 9 | Active | | | |
| 10 | Active | Queued | | |
| 11 | | Addressed | Active | |
| 12 | Active | | | |
| 13 | | | | Active |
| 14 | | Active | | Ended |
| 15 | | Active | | |
| | [symbol] | [symbol] | [symbol] | |

Three work items carry over to the next time interval.

Event Analysis Platform 110 decomposes the activity record, and WFM Platform 115 calculates the AHT and the staff requirement as shown in Table 4.

TABLE 4
ANALYSIS OF ACTIVITY RECORD
FOR FIRST TIME INTERVAL

| | | | | | | Staff |
|---|---|---|---|---|---|---|
| Work | | | | Handle | | Require- |
| Item | Received | Addressed | Active | Time | AHT | ment |
| Service | 1 | 1 | 1 | 11 | 5.5 | 0.73 |
| Chat | | | | | | |
| Service | 1 | 1 | 0 | 2 | 2 | 0.13 |
| Twitter | | | | | | |
| Service | 1 | 1 | 0 | 2 | 2 | 0.13 |
| Facebook | | | | | | |

The handle time for the service chat is the combination of the time spent on both service chats (9 minutes of active time in the first service chat and 2 minutes of active time in the second service chat). In various embodiments, the active count includes only those work items that were not answered or addressed in the same time interval to avoid double counting.

Event Analysis Platform 110 then creates a second activity record for a second time interval of 15 minutes for the three work items that carried over, as shown in Table 5.

TABLE 5
ACTIVITY RECORD FOR SECOND TIME INTERVAL

| | Service Chat | Service Chat | Service Twitter | |
|---|---|---|---|---|
| | [symbol] Carried | [symbol] Carried | [symbol] Carried | |
| | over from | over from | over from | |
| | Previous | Previous | Previous | Service |
| Minute | Interval | Interval | Interval | Facebook |
| 1 | Active | | | |
| 2 | Active | | | |
| 3 | Active | | | |
| 4 | Ended | Active | | |
| 5 | | Active | | |
| 6 | | Ended | Active | |
| 7 | | | Active | |
| 8 | | | Active | |
| 9 | | | Active | |
| 10 | | | Active | |
| 11 | | | Active | |
| 12 | | | Active | |
| 13 | | | Active | |
| 14 | | | Active | |
| 15 | | | Active | |
| | | | [symbol] | |

One work item carries over to the next time
interval.

Event Analysis Platform 110 decomposes this activity record, and WFM Platform 115 calculates the AHT and the staff requirement as shown in Table 6.

TABLE 6
ANALYSIS OF ACTIVITY RECORD
FOR SECOND TIME INTERVAL

| | | | | | | Staff |
|---|---|---|---|---|---|---|
| Work | | | | Handle | | Require- |
| Item | Received | Addressed | Active | Time | AHT | ment |
| Service | 0 | 0 | 2 | 5 | 2.5 | 0.33 |
| Chat | | | | | | |
| Service | 0 | 0 | 1 | 10 | 10 | 0.67 |
| Twitter | | | | | | |
| Service | 0 | 0 | 0 | 0 | 0 | 0 |
| Facebook | | | | | | |

In one or more embodiments, method 200 may be used in blended environments. In a blended environment, work items are assigned to employees from two or more work streams. Typically, the work streams are dissimilar in many respects (type of work, arrival patterns, service level objectives, or skills required to complete the tasks).

Two industry trends are developing renewed interest in seeking methods to be more effective and efficient in the use of an employee's paid time. One trend is the accelerating adoption of digital channels to create omni-channel contact centers. The second trend is the desire to blend work assigned to an employee from a contact center and a back office to gain efficiencies and increase employee engagement. Both trends introduce a new complexity to WFM systems. The new complexity is the need to account for and support non-homogeneous time interval modalities to minimize inaccuracy.

For example, back office operations typically plan work and optimize schedules using a time interval of 24 hours because a work item that arrives in one interval can be deferred to future intervals, a work item is typically asynchronous, a work item may or may not have a lifespan or handle time over the course of more than one time interval, and a work item typically is not abandoned.

In another example, omni-channel contact centers typically plan work and optimize schedules using time intervals of 1 to 12 hours in duration because a work item that arrives in one interval may be deferred to future intervals, or may not be deferable to another interval depending on the channel and customer expectations, a work item may be asynchronous, while other work items may be synchronous, a work item typically has a lifespan or handle time over the course of more than one planning interval, and a work item may or may not be abandoned.

In yet another example, traditional contact centers typically plan work and optimize schedules using time intervals of 15 minutes to 30 minutes in duration because a work item that arrives in one interval is not deferable to another interval, a work item may be asynchronous (e.g., technical support calls with periods of hold time), while other work items may be synchronous (e.g., general inquiry calls), a work item typically has a lifespan or a handle time less than or equal to a time interval, and a work item is abandoned if not handled in a timely manner.

In yet another example, branch, retail, field services and other service or sales operations typically plan work and optimize schedules using time intervals of 15 minutes to 24 hours (or more) because a work item that arrives in one interval may or may not be deferrable, may be synchronous or asynchronous, may have a lifespan shorter than or longer than the planning interval and may or may not abandon if not handled in a timely manner.

It is not uncommon to see a single organization attempt to manage two or more environments in a single cohesive plan, even though most environments have completely different planning time intervals. As such, for a WFM system to be effective in planning and optimizing schedules for blended employees, all the time intervals across all the environments must be normalized to the lowest common denominator or the smallest time interval and work items must be decomposed into the lowest common denominator planning time interval. For example, a blended contact center and back office must have the back-office case work normalized to the contact centers' 15 or 30 minute time interval, even though the back office requires 24-hour time intervals for inventory insights. Although the normalization to the smallest time intervals could be accomplished with simple averages or equal distribution of workload from the higher time interval to the lowest time interval, a more accurate approach is needed to ensure plans and schedules consider the variable needs of all the work streams in the environment. Advantageously, the present methods resolve the challenges of normalizing workloads into the lowest common denominator time interval for omni-channel and blended environments.

In several embodiments, WFM Platform 115's forecast algorithms and staffing requirement calculations are further modified to simultaneously support work item based work streams and work activity based work streams in a single instance for a cohesive combined plan of workload, staffing requirements, and optimized schedules at the lowest common denominator for the time interval.

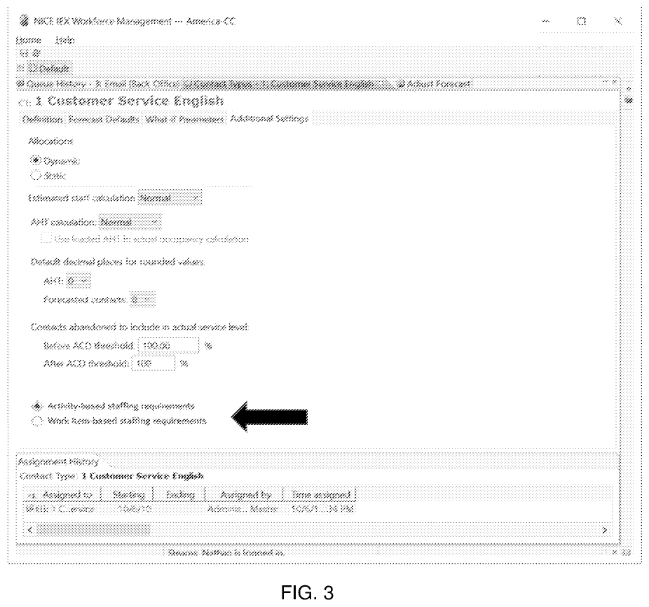

Referring now to FIG. 3, shown is a representative example of a WFM administrative screen used to define the parameters for each organization that will receive a work volume forecast and staffing requirements. In the example, a user has the option to calculate staffing requirements based on work activity volume and AHT, or calculate staffing requirements based on work item volume and AHT. Organizations that are defined to use activity-based staffing requirements rely on historical data that represents decomposition of work items into the relevant time interval.

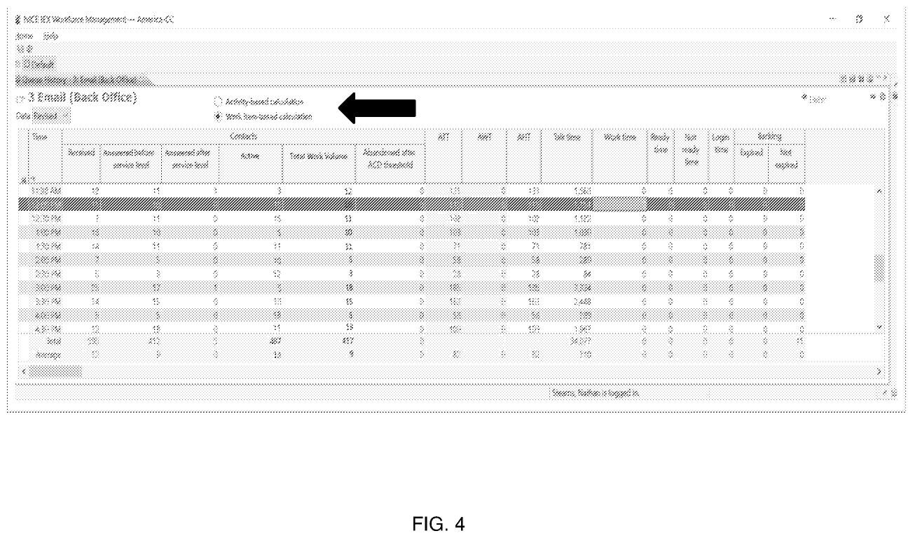

FIG. 4 is a representative example of a WFM queue history screen for an organization using the work item-based staffing requirement option. Although the active column is populated with data, the total work volume does not include the count of active work items. As such, the forecast of volume and AHT is a representation of the work items rather than the work activities associated with the work items.

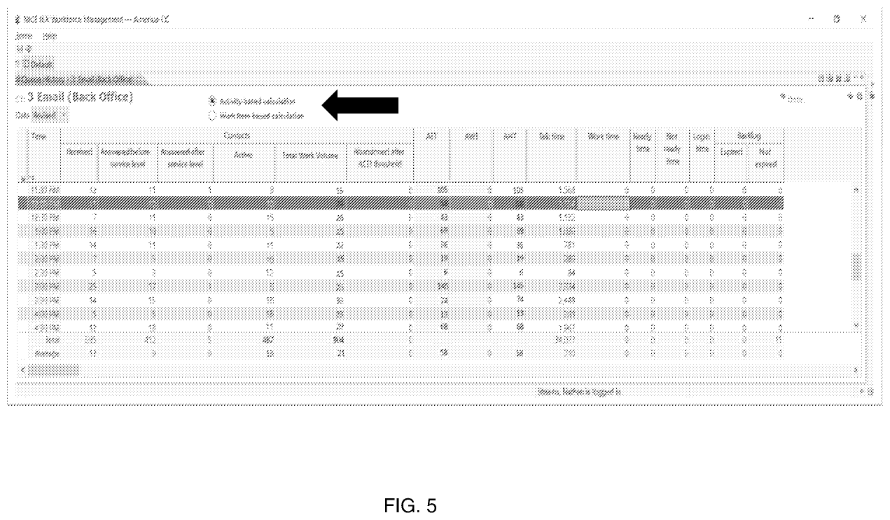

FIG. 5 is a representative example of a WFM queue history screen for an organization using the activity-based staffing requirement option. The active column is populated with data and the total work volume includes the count of active work items. As such, the forecast of volume and AHT is a representation of the work activities associated with work items rather than the work items.

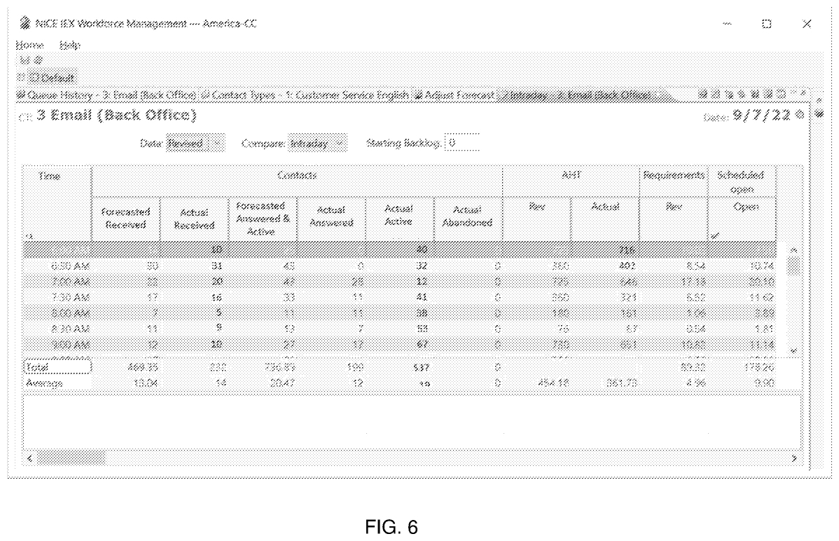

FIG. 6 is a representative example of a WFM intraday analysis screen for an organization using the activity-based staffing requirement option. In addition to the traditional reporting of the number of work items addressed (answered) in each interval, the screen also includes the number of work items that were active in each interval. This represents the decomposition of work items that have lifespans across the intervals. The sum of addressed and active can be different than the work items received in the interval. This is because (1) the initial addressing (answering) of work items can be deferred to future intervals, and (2) a work item can be active and inactive periodically throughout the day. This screen demonstrates an embodiment of how work items with sporadic activity over many intervals can be decomposed and normalized into the smallest time interval (in the example, the smallest time interval is 30 minutes).

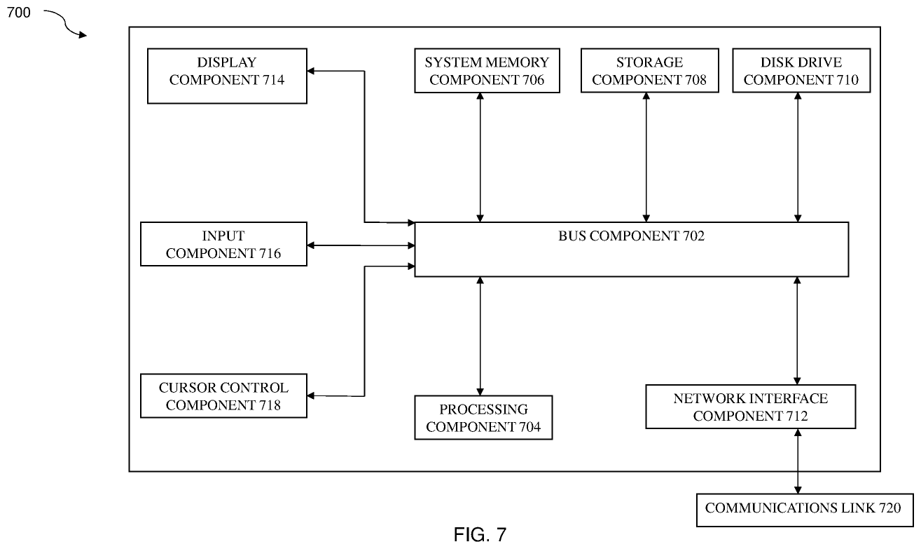

Referring now to FIG. 7, illustrated is a block diagram of a system 700 suitable for implementing embodiments of the present disclosure. System 700, such as part a computer and/or a network server, includes a bus 702 or other communication mechanism for communicating information, which interconnects subsystems and components, including one or more of a processing component 704 (e.g., processor, micro-controller, digital signal processor (DSP), etc.), a system memory component 706 (e.g., RAM), a static storage component 708 (e.g., ROM), a network interface component 712, a display component 714 (or alternatively, an interface to an external display), an input component 716 (e.g., keypad or keyboard), and a cursor control component 718 (e.g., a mouse pad).

In accordance with embodiments of the present disclosure, system 700 performs specific operations by processor 704 executing one or more sequences of one or more instructions contained in system memory component 706. Such instructions may be read into system memory component 706 from another computer readable medium, such as static storage component 708. These may include instructions to receive, from a work item routing platform, a real-time event stream or historical event data for a plurality of work items; create an activity record for each work item from the plurality of work items, wherein the activity record for each work item is divided into a plurality of time intervals; specify a first time interval; determining a number of the plurality of work items that were initially addressed in the first time interval; determine, for work items not initially addressed in the first time interval, a total number of active work items in the first time interval; determine which work items were not completed in the first time interval; carry over work items not completed in the first time interval for analysis in a subsequent time interval; aggregate time spent working on the work items initially addressed in the first time interval and the active work items in the first time interval to determine a total handle time in the first time interval; provide, to a workforce management (WFM) system, the number of initially addressed work items in the first time interval, the total number of active work items in the first time interval, and the total handle time in the first time interval; generate, by the WFM, a forecast of a second number of initially addressed work items for the first time interval, a forecast of a second total number of active work items in the first time interval, and a forecast of an average handle time (AHT) in the first time interval; and compute, by the WFM, a staff requirement for the first time interval using the second number of forecasted initially addressed work items, the second total number of forecasted active work items, and the forecasted AHT for the first time interval.

In other embodiments, hard-wired circuitry may be used in place of or in combination with software instructions for implementation of one or more embodiments of the disclosure.

Logic may be encoded in a computer readable medium, which may refer to any medium that participates in providing instructions to processor 704 for execution. Such a medium may take many forms, including but not limited to, non-volatile media, volatile media, and transmission media. In various implementations, volatile media includes dynamic memory, such as system memory component 706, and transmission media includes coaxial cables, copper wire, and fiber optics, including wires that comprise bus 702. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 700. In various other embodiments, a plurality of systems 700 coupled by communication link 720 (e.g., LAN, WLAN, PTSN, or various other wired or wireless networks) may perform instruction sequences to practice the disclosure in coordination with one another. Computer system 700 may transmit and receive messages, data, information and instructions, including one or more programs (i.e., application code) through communication link 720 and communication interface 712. Received program code may be executed by processor 704 as received and/or stored in disk drive component 710 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. An interval-specific, activity-based system comprising:
a processor and a computer readable medium operably coupled thereto, the computer readable medium comprising a plurality of instructions stored in association therewith that are accessible to, and executable by, the processor, to perform operations which comprise:
receiving, from a work item routing platform, a real-time event stream or historical event data for a plurality of work items;
creating an activity record for each work item from the plurality of work items, wherein the activity record for each work item is divided into a plurality of time intervals;
specifying a first time interval;
determining a number of the plurality of work items that were initially addressed in the first time interval;
determining, for work items not initially addressed in the first time interval, a total number of active work items in the first time interval;
determining which work items were not completed in the first time interval;
carrying over work items not completed in the first time interval for analysis in a subsequent time interval;
aggregating time spent working on the work items initially addressed in the first time interval and the active work items in the first time interval to determine a total handle time in the first time interval;
providing, to a workforce management (WFM) system, the number of initially addressed work items in the first time interval, the total number of active work items in the first time interval, and the total handle time in the first time interval;
generating, by the WFM, a forecast of a second number of initially addressed work items for the first time interval, a forecast of a second total number of active work items in the first time interval, and a forecast of an average handle time (AHT) in the first time interval; and
computing, by the WFM, a staff requirement for the first time interval using the second number of forecasted initially addressed work items, the second total number of forecasted active work items, and the forecasted AHT for the first time interval.

2. The interval-specific, activity-based system of claim 1, wherein the work item routing platform comprises an automatic contact distributor (ACD).

3. The interval-specific, activity-based system of claim 1, wherein the first time interval is about 15 minutes to about 30 minutes.

4. The interval-specific, activity-based system of claim 1, wherein determining the total number of active work items in the first time interval comprises determining a total number of the plurality of work items that were focused on by a plurality of employees in the first time interval.

5. The interval-specific, activity-based system of claim 4, wherein the plurality of employees are employed at a blended environment, and the operations further comprise normalizing the first time interval to a smallest time interval used in the blended environment.

6. The interval-specific, activity-based system of claim 1, wherein the operations further comprise determining, for the work items not completed in the first time interval, a total number of active work items in the subsequent time interval.

7. The interval-specific, activity-based system of claim 1, wherein the plurality of work items comprise an asynchronous work item, a synchronous work item, or a combination thereof, each asynchronous work item or synchronous work item having a handle time that exceeds the first time interval.

8. The interval-specific, activity-based system of claim 7, wherein the plurality of work items comprise an asynchronous work item that is selected from an email, a chat, a post on a forum, a message on a messenger application, a post on a social networking site, a text, an in-app message, a search on a search engine, or a combination thereof.

9. The interval-specific, activity-based system of claim 7, wherein the plurality of work items comprise a synchronous work item that is selected from a telephone conversation, an interactive voice response (IVR), an instant message, a video chat, a live meeting, or a combination thereof.

10. A method for determining staffing needs at an organization, which comprises:
receiving, from a work item routing platform, a real-time event stream or historical event data for a plurality of work items;
creating an activity record for each work item from the plurality of work items, wherein the activity record for each work item is divided into a plurality of time intervals;
specifying a first time interval;
determining a number of the plurality of work items that were initially addressed in the first time interval;
determining, for the work items not initially addressed in the first time interval, a total number of active work items in the first time interval;
determining which work items were not completed in the first time interval;
carrying over work items not completed in the first time interval for analysis in a subsequent time interval;
aggregating time spent working on the work items initially addressed in the first time interval and the active work items in the first time interval to determine a total handle time in the first time interval;
providing, to a workforce management (WFM) system, the number of initially addressed work items in the first time interval, the total number of active work items in the first time interval, and the total handle time in the first time interval;
generating, by the WFM, a forecast of a second number of initially addressed work items for the first time interval, a forecast of a second total number of active work items in the first time interval, and a forecast of an average handle time (AHT) in the first time interval; and
computing, by the WFM, a staff requirement for the first time interval using the second number of forecasted initially addressed work items, the second total number of forecasted active work items, and the forecasted AHT for the first time interval.

11. The method of claim 10, wherein the first time interval is about 15 minutes to about 30 minutes.

12. The method of claim 10, wherein determining the total number of active work items in the first time interval comprises determining a total number of the plurality of work items that were focused on by a plurality of employees in the first time interval.

13. The method of claim 12, wherein the plurality of employees are employed at a blended environment, and the method further comprises normalizing the first time interval to a smallest time interval used in the blended environment.

14. The method of claim 10, which further comprises determining, for the work items not completed in the first time interval, a total number of active work items in the subsequent time interval.

15. The method of claim 10, wherein the plurality of work items comprise an asynchronous work item, a synchronous work item, or a combination thereof, each asynchronous work item or synchronous work item having a handle time that exceeds the first time interval.

16. A non-transitory computer-readable medium having stored thereon computer-readable instructions executable by a processor to perform operations which comprise:
receiving, from a work item routing platform, a real-time event stream or historical event data for a plurality of work items;
creating an activity record for each work item from the plurality of work items, wherein the activity record for each work item is divided into a plurality of time intervals;
specifying a first time interval;
determining a number of the plurality of work items that were initially addressed in the first time interval;
determining, for work items not initially addressed in the first time interval, a total number of active work items in the first time interval;
determining which work items were not completed in the first time interval;
carrying over work items not completed in the first time interval for analysis in a subsequent time interval;
aggregating time spent working on the work items initially addressed in the first time interval and the active work items in the first time interval to determine a total handle time in the first time interval;
providing, to a workforce management (WFM) system, the number of initially addressed work items in the first time interval, the total number of active work items in the first time interval, and the total handle time in the first time interval;
generating, by the WFM, a forecast of a second number of initially addressed work items for the first time interval, a forecast of a second total number of active work items in the first time interval, and a forecast of an average handle time (AHT) in the first time interval; and
computing, by the WFM, a staff requirement for the first time interval using the second number of forecasted initially addressed work items, the second total number of forecasted active work items, and the forecasted AHT for the first time interval.

17. The non-transitory computer-readable medium of claim 16, wherein the first time interval is about 15 minutes to about 30 minutes.

18. The non-transitory computer-readable medium of claim 16, wherein determining the total number of active work items in the first time interval comprises determining a total number of the plurality of work items that were focused on by a plurality of employees in the first time interval.

19. The non-transitory computer-readable medium of claim 18, wherein the plurality of employees are employed at a blended environment, and the operations further comprise normalizing the first time interval to a smallest time interval used in the blended environment.

20. The non-transitory computer-readable medium of claim 16, wherein the operations further comprise determining, for the work items not completed in the first time interval, a total number of active work items in the subsequent time interval.
